(19) United States
(12) Patent Application Publication
(10) Pub. No.: US 2005/0122076 A1
(43) Pub. Date: Jun. 9, 2005

(54) Barrier closure system

(75) Inventors: John Patchell, Carleton Place (CA); Bernd Pottner, Carleton Place (CA)

Correspondence Address: GOWLING LAFLEUR HENDERSON, LLP, Suite 2600, 160 Elgin Street, Ottawa, ON, K1P 1C3, CA

(73) Assignee: PathMinder Inc.

(21) Appl. No.: 10/957,580

(22) Filed: Oct. 5, 2004

Related U.S. Application Data
(60) Provisional application No. 60/509,235, filed on Oct. 8, 2003.

(51) Int. Cl. H02P 1/00

(52) U.S. Cl. 318/280

(57) ABSTRACT

An obstacle detection method and system for a barrier closure system comprising a sensor for measuring a predetermined parameter as it varies during a closure of a barrier. Memory stores the measured parameter to establish a first parameter profile and a threshold value associated therewith. A detection module compares a current value of the predetermined parameter to a corresponding barrier position of the first parameter profile and if the current value differs by more than a threshold value sets an obstacle detection state. Conveniently the profile is recalibrated to compensate for changes in the barrier closure system such as wear, and environmental conditions that may vary over time. Preferably the sensor includes a capacitance component.

### FIELD OF THE INVENTION

The present invention relates to barrier closure systems and is particularly concerned with obstruction detection.

### BACKGROUND OF THE INVENTION

For automatic barriers such as gates or doors it is important to stop the gate motion when an obstruction is in the path of the gate. This issue has typically been addressed with mechanical contact sensors, for example as is commonly seen on elevator doors. Another approach is the use of beams, typically infrared, located next to the gate, or other non-contacting sensors, such as capacitance sensors taught in U.S. Pat. No. 5,337,039 and U.S. patent application 2003/0071727 published 17 Apr. 2003.

For opposed sliding gates, that is one gate coming from each side of an opening and moving horizontally, it is desirable to have the gates come close together in the closed position and retract fully into the housing when in the open position. For a capacitance edge sensor this poses a problem because the capacitance between the housing in the open position and between the two sensors in the closed position can be much larger than the change caused by the presence of an obstruction, for example a hand.

Previous attempts to address this issue have simply reduced the sensitivity and in some cases turned the safety device off when the gate was approaching the limits of its travel.

### SUMMARY OF THE INVENTION

An object of the present invention is to provide an improved gate closure system.

In accordance with an aspect of the present invention there is provided an obstacle detection system for a barrier closure system comprising a sensor for measuring a predetermined parameter as it varies during a closure of a barrier, a memory for storing the measured parameter to establish a first parameter profile and a threshold value associated therewith and a detection module for comparing a current value of the predetermined value to a corresponding barrier position of the first parameter profile and if the current value differs by more than a threshold value, setting an obstacle detection state.

In accordance with another aspect of the present invention there is provided a method of obstacle detection for a barrier closure system comprising the steps of:
1) sensing and storing a predetermined parameter as it varies during a closure of a barrier to establish a first parameter profile,
2) on subsequent closures, sensing the predetermined parameter and comparing a current value of the predetermined value to a corresponding barrier position of the first parameter profile, and
3) if the current value differs by more than a threshold value, setting an obstacle detection state.

### BRIEF DESCRIPTION OF THE DRAWINGS

The present invention will be further understood from the following detailed description with reference to the drawings in which:

FIG. 1 illustrates a pair of turnstiles with sliding doors and including a sensor for detecting obstructions in accordance with an embodiment of the present invention;

FIG. 2 illustrates a pair of turnstiles with angel wing doors or gates and including a sensor for detecting obstructions in accordance with an embodiment of the present invention;

FIG. 3 illustrates in a perspective view detail of one turnstile of FIG. 1;

FIG. 4 graphically illustrates a capacitance profile for the sensor of FIG. 1;

FIG. 5 illustrates in a block diagram the gate closure system for the turnstile of FIG. 1;

FIG. 6 illustrates in a block diagram the signal and data flow for the system of FIG. 5;

FIG. 7 illustrates, in a flow chart, sensor and obstruction detection control logic for the system of FIG. 5;

FIG. 8 illustrates, in a flow chart, the step of acquiring a base profile of FIG. 7;

FIG. 9 illustrates, in a flow chart, the step of obstacle detection of FIG. 7; and

FIG. 10 illustrates, in a flow chart, the step of process detection algorithm of FIG. 9.

### DETAILED DESCRIPTION OF THE PREFERRED EMBODIMENT

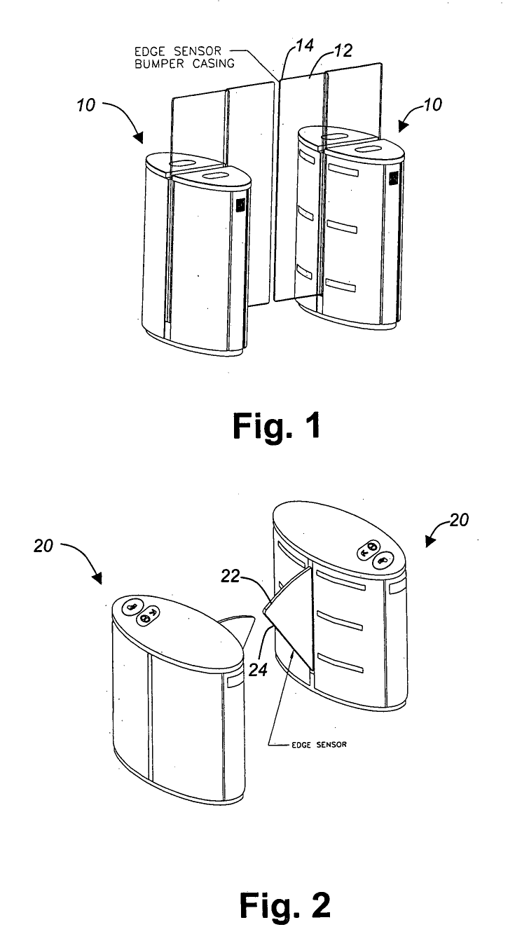

Referring to FIG. 1, there is illustrated a pair of turnstiles with sliding doors including a sensor for detecting obstructions in accordance with an embodiment of the present invention. Each turnstile 10 includes a sliding gate 12 having an edge-mounted sensor 14.

Referring to FIG. 2, there is illustrated a pair of turnstiles with angel wing doors or gates including a sensor for detecting obstructions in accordance with an embodiment of the present invention. Each turnstile 20 includes a pivoting gate 22 having an edge-mounted sensor 24.

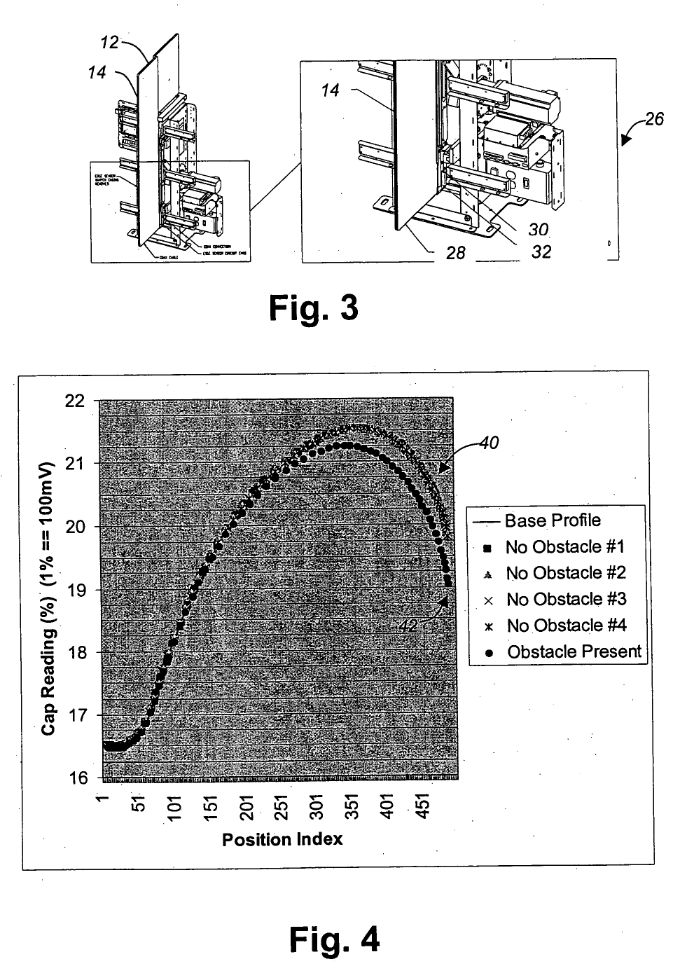

Referring to FIG. 3, there is illustrated in a perspective view detail of one turnstile of FIG. 1. The internal gate closure mechanism is shown with outer housing removed. A detailed section thereof 26 shows a portion of the sliding gate 12 with its edge-mounted sensor 14 connected via a coaxial cable 28 and a coax connector 30 to a sensor circuit card 32.

Referring to FIG. 4, there is graphically illustrated a capacitance profile for the sensor of FIG. 1. A base profile 40 is established by measuring capacitance during a plurality of door operations with out foreign objects present (no obstacles). Then during each subsequent operation, the capacitance profile is compared to the base profile 40. When an obstacle is present, a shift in the capacitance profile occurs as shown in curve 42. This shift is used by the obstacle detection system as described herein below.

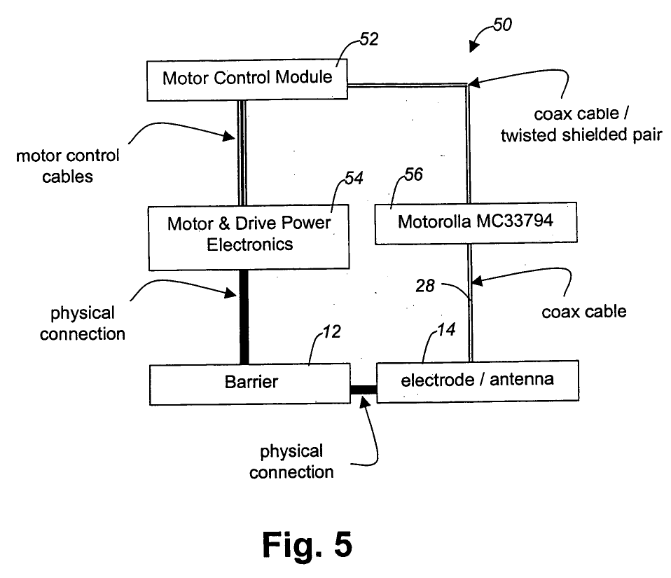

Referring to FIG. 5, there is illustrated in a block diagram the gate closure system for the turnstile of FIG. 1. The gate closure system 50 includes a motor control module 52, motor and drive electronics 54 and sensor electronics 56. Sensor electronics 56 uses a Motorola MC 33794 as the capacitance sensing electronics. This chip energizes the sensor 14 with a very stable 120 kHz signal and measures the drop across a resistor to determine the loading due to the sensor (and hence its capacitance). The sensor 14, in the case of a non-metallic gate, can be almost any metallic strip. For example, an adhesive backed aluminum foil and a stainless steel strip about 1.5 cm wide in a plastic tube have both provided very good performance. It is important to insure the sensor remains firmly fixed to the gate to avoid unexpected changes in capacitance, i.e. changes not associated with the movement of the gate. The sensor electronics 56 are connected to the sensor 14 with a short length of coaxial cable 28. At the electronics end 56 the cable shield is connected to the shield terminal of the MC 33974 and the center conductor to the E1 terminal (or E2 to E9 if they are selected). At the sensor end 14 the center conductor is connected to the metallic strip and the shield is left unconnected. This configuration ensures that the coax cable 28 is not sensitive. It is important to keep the coax cable 28 relatively short to avoid excess capacitive loading that would reduce system sensitivity. Lengths up to 1 meter have been found to be quite practical.

As an alternative, a QT300 chip from Quantum Research Group could be used for the sensor electronics. This chip operates around 250 kHz and has a digital output as opposed to the analog output of the MC 33974. Either chip works quite well for this application. In fact almost any circuit that responds to capacitance changes can be used. For example, a relaxation oscillator could be used.

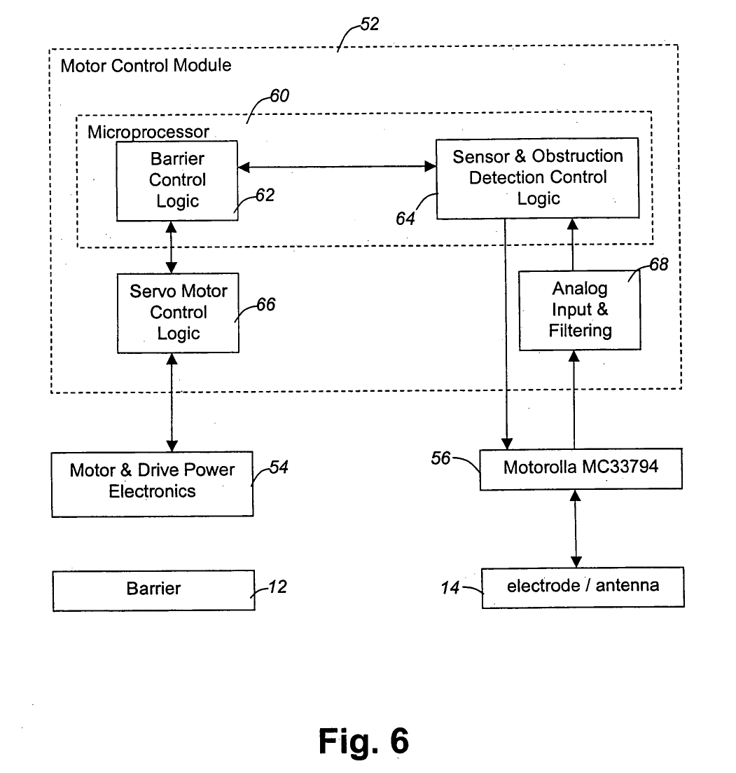

Referring to FIG. 6, there is illustrated in a block diagram the signal and data flow for the system of FIG. 5. FIG. 6 shows the motor control module 52 in further detail. The motor control module 52 includes a microprocessor 60, having barrier 62 and sensor and obstruction detection 64 control logic, servo motor control logic 66 and analog input and filtering 68.

In an embodiment of the present invention, the problem of varying capacitance illustrated in FIG. 4 is addressed by recording the capacitance as a function of position as the gate travels from the open to the closed position during a calibration run and then using this stored data to compare to the measured capacitance during operation. Any deviation from the stored pattern indicates an object in proximity to the sensor. This causes a signal to be sent to the motor control module to stop the gate moving or to reverse direction as desired.

Once the gate is stopped due to a foreign object, the capacitance can continue to be monitored. If the object is removed, then gate motion can be resumed. If the object comes closer, the gate can be backed off to maintain a separation between the object and the gate.

Environmental changes that occur slowly (for example, wear in the mechanism or a buildup of dirt) can be compensated for with an adaptive algorithm that records the capacitance versus position profile for each gate operation and adjusts the stored profile by a small fraction of the currently measured profile. If an obstruction is detected or a high dynamic response is seen on the capacitance readings during a move, the adaptive algorithm can be disabled, thereby ensuring that only the true gradual environmental changes are worked into the stored profile.

A second variation of this technique records the capacitance as a function of time. For this implementation the system does not need a continuous reading of gate position but instead assumes that the gate moves with the same position vs. time profile each time it operates. The only information needed is the time the gate starts moving and the time it stops moving. This makes the system somewhat less sensitive because of variations of how the gate moves with time due to different loadings, machine wear etc., but these changes could be compensated for by an adaptive algorithm that learns the capacitance vs. time profile as the gate operates. The advantage of this second approach is that the sensor is less intimately connected to the gate mechanism and thus becomes easier to retrofit to existing systems.

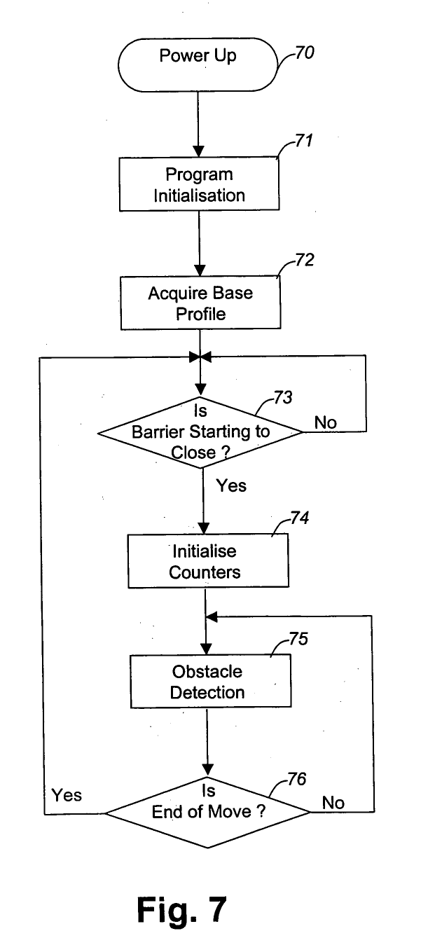

Referring to FIG. 7, there is illustrated, in a flow chart, operation of the sensor and obstruction detection control logic for the system of FIG. 5. The sensor and obstruction control logic begins operation with power up 70, program initialization 71 and acquire base profile 72 steps. A decision block 73 determines if the barrier (gate or door) is starting to close, if No the process loops back and continues to query until a Yes occurs causing counters to initialize 74, followed by obstacle detection 75 and a decision block 76 querying if movement of the barrier has ended. A Yes loops the process back to before decision block 73 while a No loops the process back prior to the obstacle detection 75.

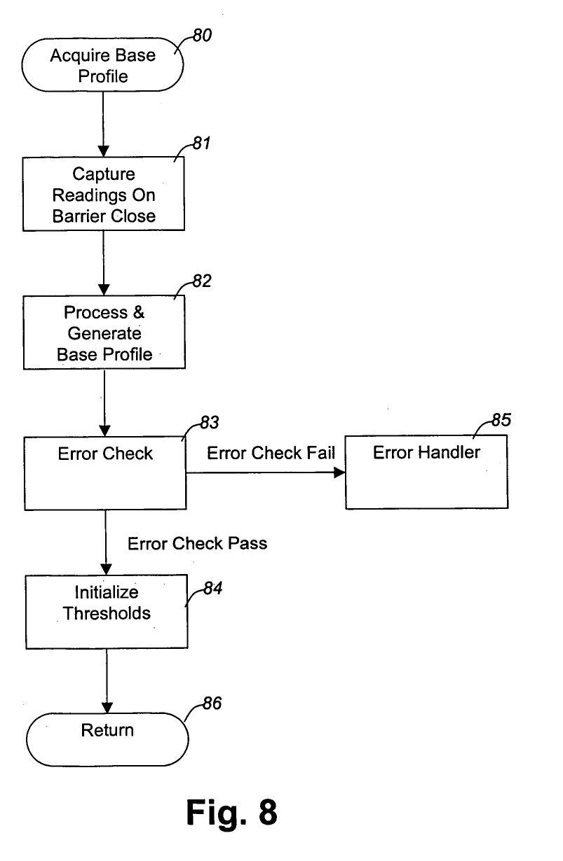

Referring to FIG. 8, there is illustrated, in a flow chart, the step of acquiring a base profile of FIG. 7. The acquire profile step 72 of FIG. 7 begins at a block 80. Sensor readings are stored as the barrier is closed as represented by a capture readings on barrier close block 81. A process and generate base profile block 82 creates an initial capacitance profile 40. This profile is error checked 83 and if passed is followed by initializing thresholds 84 associated with the base profile 40. If an error check fails an error handler block 85 is called. A return block 86 completes the acquire profile step 72.

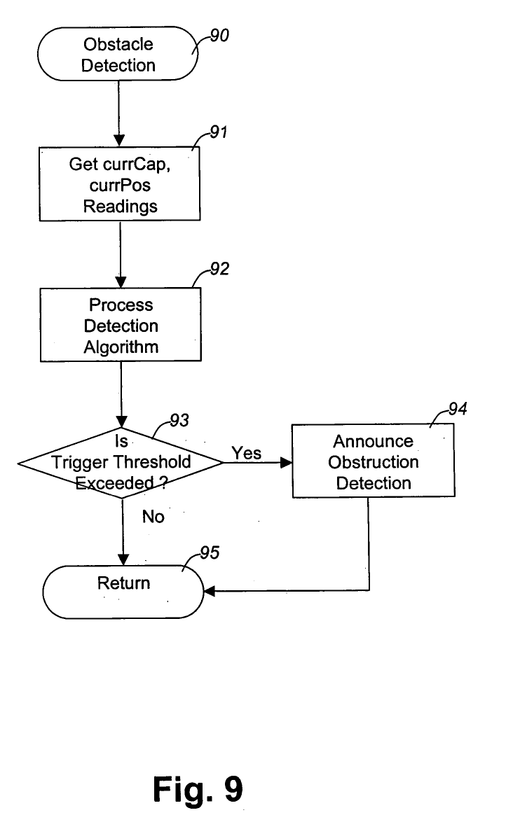

Referring to FIG. 9, there is illustrated, in a flow chart, the step of obstacle detection of FIG. 7. The obstacle detection step 75 of FIG. 7 begins at a block 90. Current sensor readings and current position readings are obtained as represented by a block 91. A process detection algorithm block 92 compares the current readings to the capacitance profile 40. A decision block 93 determines if a trigger threshold is exceeded. If Yes, an announce obstruction detection block 94 is called. A return block 95 completes the obstacle detection step 75.

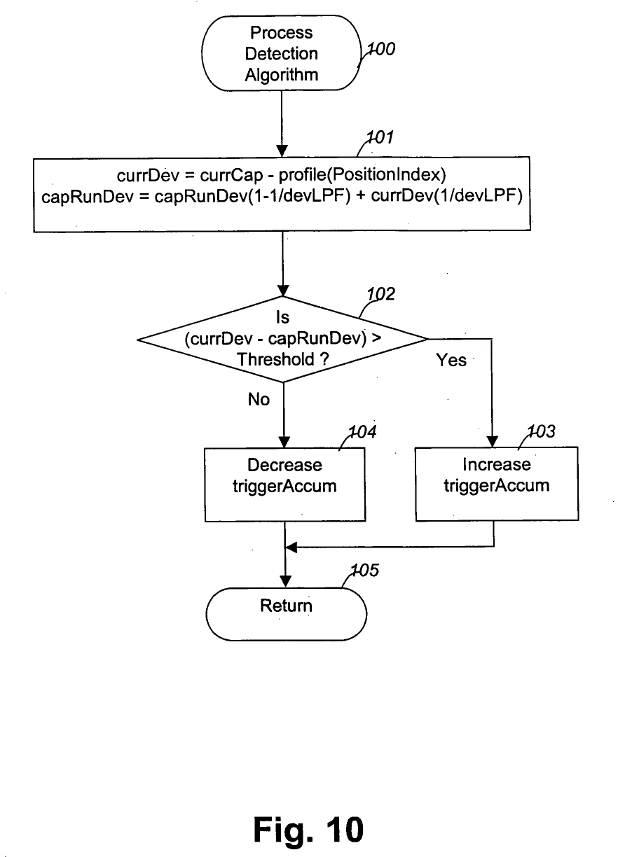

Referring to FIG. 10, there is illustrated, in a flow chart, the step of process detection algorithm of FIG. 9. The process detection algorithm step 92 of FIG. 9 begins at a block 100. Current sensor readings and current position readings are compared the current readings to the capacitance profile 40 as represented by a block 101. A decision block 102 queries whether a trigger threshold is exceeded. A Yes leads to an increase triggerAccum block 103. A No leads to a decrease triggerAccum block 104. A return block 105 completes the process detection algorithm step 92.

Hence, one possible algorithm detects obstacles by looking at how fast the capacitance readings are moving away from the base profile. This is achieved by building a running deviance value, low pass filtered over the move. Each reading as it is received is weighted into the running deviance and then compared to that deviance. An ‘obstruction trigger count’ is adjusted according to the difference between the readings' deviance from the base profile and the running deviance. The present scheme uses weighted increments and decrements to achieve a more accurate response to obstructions and at the same time to filter out transients.

This technique serves 2 major purposes:

(i) Base Profile Drift: By considering only how fast the readings are moving away from the profile any uniform drift in the actual profile (i.e. resultant of environment changes) are factored out.

(ii) Increased Sensitivity and Early Detection: The capacitance readings are subject to a number of high frequency error sources. Any one reading has a potential error of +/−10 mV in the test setup employed. The technique used here is parameterized to trigger only on encountering relatively large number of successive reading differences. Early detection is still achieved as thresholds can be set near 2 mV with this approach.

Note that the algorithm and mathematics can be implemented in a number of ways as is best suited for the performance of the particular microcontroller.

Also note that this approach is and can be used in conjunction with a number of other thresholds schemes to produce an optimum response.

The present invention is not restricted to dual opposed sliding gates and can be used with many different types of moving gates such as single gates, “angel wing gates”, lift gates, horizontal barrier arm gates and car park barrier arms.

For simplicity of the description, embodiments of the present invention have been described with capacitance-based sensors. However the present invention is not restricted to capacitance-based sensors only but could apply to any non-contact sensor providing a signal that varies significantly with gate position and reacts to the presence of obstacles. Embodiments of the present invention can also include more than one type of sensor, for example IR beams may be combined with a capacitance sensor. Such a dual technology system could be used to provide redundancy for increased safety.

Numerous modifications, variations and adaptations may be made to the particular embodiments of the invention described above without departing from the scope of the invention, which is defined in the claims.

1. A method of obstacle detection for a barrier closure system comprising the steps of:
sensing and storing a predetermined parameter as it varies during a closure of a barrier to establish a first parameter profile;
on subsequent closures, sensing the predetermined parameter and comparing a current value of the predetermined value to a corresponding barrier position of the first parameter profile; and
if the current value differs by more than a threshold value, setting an obstacle detection state.

2. A method as claimed in claim 1 wherein the step sensing and storing the predetermined parameter comprises calibrating the first parameter profile.

3. A method as claimed in claim 1 wherein the step sensing and storing the predetermined parameter comprises recalibrating the first parameter profile.

4. A method as claimed in claim 3 wherein the step of recalibrating the first parameter profile at a recalibration interval.

5. A method as claimed in any of claims 1-4 wherein the threshold value is a change of the predetermined parameter.

6. A method as claimed in any of claims 1-4 wherein the threshold value is a rate of change of the predetermined parameter.

7. A method as claimed in any of claims 1-6 wherein the corresponding barrier position is distance based.

8. A method as claimed in any of claims 1-6 wherein the corresponding barrier position is time based.

9. A method as claimed in any of claims 1-8 wherein the predetermined parameter is at least one of capacitance, an radio frequency (RF) electromagnetic wave, magnetic field strength, electric field strength, induced current.

10. A method as claimed in any of claims 1-9 further comprising the step of detecting infrared beams for providing a further obstacle detection signal.

11. An obstacle detection system for a barrier closure system comprising:
a sensor for measuring a predetermined parameter as it varies during a closure of a barrier;
a memory for storing the measured parameter to establish a first parameter profile and a threshold value associated therewith; and
a detection module for comparing a current value of the predetermined value to a corresponding barrier position of the first parameter profile and if the current value differs by more than a threshold value, setting an obstacle detection state.

12. An obstacle detection system as claimed in claim 11 wherein the detection module includes a module for calibrating the first parameter profile.

13. An obstacle detection system as claimed in claim 12 wherein the module for calibrating includes a capability for recalibrating the first parameter profile.

14. An obstacle detection system as claimed in claim 13 wherein the capability for recalibrating the first parameter profile includes a recalibration interval.

15. An obstacle detection system as claimed in any of claims 10-14 wherein the threshold value is a change of the predetermined parameter.

16. An obstacle detection system as claimed in any of claims 10-14 wherein the threshold value is a rate of change of the predetermined parameter.

17. An obstacle detection system as claimed in any of claims 10-16 wherein the corresponding barrier position is distance based.

18. An obstacle detection system as claimed in any of claims 10-16 wherein the corresponding barrier position is time based.

19. An obstacle detection system as claimed in any of claims 10-18 wherein the predetermined parameter is at least one of capacitance, an radio frequency (RF) electromagnetic wave, magnetic field strength, electric field strength, induced current.

20. An obstacle detection system as claimed in any of claims 10-19 further comprising infrared sensors coupled to the detection module for providing a further obstacle detection signal thereto.
